(19) United States
(12) Patent Application Publication
(10) Pub. No.: US 2009/0315376 A1
(43) Pub. Date: Dec. 24, 2009

(54) RECLINABLE CHAIR WITH ADJUSTABLE PARALLEL LOCKING GAS SPRING DEVICE

(76) Inventor: Takuro Nishiwaki, Ontario (CA)

Correspondence Address: THORPE NORTH & WESTERN, LLP., P.O. Box 1219, SANDY, UT, 84091-1219, US

(21) Appl. No.: 12/480,879

(22) Filed: Jun. 9, 2009

Related U.S. Application Data
(60) Provisional application No. 61/073,887, filed on Jun. 19, 2008.

(51) Int. Cl. A47C 1/024; F16F 9/18; B23P 13/00

(52) U.S. Cl. 297/301.2; 267/124; 29/896.92

(57) ABSTRACT

A gas spring device includes a pair of gas springs disposed parallel and adjacent one another. Each of the gas springs has a piston extendable in an opposite direction from the piston of the other gas spring. An adjustable coupling joins the pair of gas springs together and is adjustable to selectively position one of the gas springs along a longitudinal length of the other gas spring in order to adjust the overall piston-to-piston length of the gas spring device. Additionally, an inclinable chair can include the gas spring device to allow a chair frame to be selectively positioned at a desired angle of inclination with respect to a base frame.

### RELATED APPLICATIONS

This application claims priority to U.S. Provisional Application No. 61/073,887, filed Jun. 19, 2008, and entitled “Reclining Chair with Adjustable Parallel Locking Gas Spring Device,” which application is incorporated by reference in its entirety herein.

### FIELD OF THE INVENTION

The present invention relates generally to chairs and more particularly to chairs with tiltable seats, reclinable backrests, extendable footrests, elevating leg rests, and the like.

### BACKGROUND OF THE INVENTION AND RELATED ART

Gas springs, indicated generally at 10 in FIG. 1, are well known and commercially available. Such gas springs often use a compressed gas, contained in a cylinder 12 and variably compressed by a piston 14, to exert a force. Thus, the piston can be extended out (not shown) from the cylinder or compressed into the cylinder, as shown in FIG. 1, depending on the force applied to the piston.

Such gas springs are often used to assist in opening and/or positioning a movable component with respect to a surrounding frame or structure. For example, gas springs 10 are often used to help open and retain in position doors, lids, cabinets, drawers, and the like. Additionally, gas springs have been used to help pivot and position backrests 22 or seats 24 on chairs, indicated generally at 20, as shown in FIGS. 2 and 3. Thus, as shown in FIG. 2, a gas spring 10 can be used to position a chair seat, indicated generally at 26, in a substantially upright position by extending and locking the piston 14 in an extended position. Similarly, as seen in FIG. 3, the gas spring 10 can be used to recline the chair 26 seat by moving the piston 14 to the compressed position.

Generally, the overall extended length to compressed length ratio is around 2:1. That is, the length of the piston 14 is approximately the same length as the cylinder 12 so that with the piston in the extended state the overall length of the gas spring 10 is about twice the length as when the piston is in the compressed state. Additionally, the cylinder is often longer than the piston such that the compressed length is longer than the total stroke of the gas spring. Thus, the movable component, such as the chair seat in FIGS. 2-3, can only be moved within this extended-to-compressed length ratio range.

To overcome these fundamental constraints on the lengths of gas springs, attachments or mounting points 16 have been designed that effectively increase a gas spring's 10 extended-to-compressed length ratio by creating a mounting point that is located along the length of the cylinder body 12. For example, the attachment 16 can be a mounting point can be added on the cylinder body that is closer to the rod exit point.

While such attachments can change the effective extended-to-compressed length ration, unfortunately, they also create a cumbersome remaining appendage 18 that extends behind the new mounting point 16. Often these appendages must be negotiated or designed around when designing the structure to which a gas spring may be attached. Additionally, many times the protruding appendage can hinder and interfere with other nearby components or framework.

Moreover, it is not possible to currently lengthen the extended length of a gas spring beyond its overall extended length. Similarly, it is not possible to shorten the compressed length of a gas spring other than with an attachment as described above.

### SUMMARY OF THE INVENTION

The inventor of the present invention has recognized that it would be advantageous to develop a method and device for increasing the effective length of a gas spring device beyond the overall length of a single gas spring. Additionally, the inventor has recognized that it would be advantageous to use a gas spring device with an extended length gas spring device on a reclinable or inclinable chair.

The invention provides a gas spring device including a pair of gas springs disposed parallel and adjacent one another. Each of the gas springs can have a piston extendable in an opposite direction from the piston of the other gas spring. An adjustable coupling can join the pair of gas springs together and is adjustable to selectively position one of the gas springs along a longitudinal length of the other gas spring in order to adjust the overall extended piston-to-piston length of the gas spring device.

In another aspect, the invention provides for an inclinable chair including a base frame configured to rest upon a support surface. A chair frame can be movably coupled to the base frame. The chair frame can have at least one inclinable portion. A parallel locking gas spring device can be operably coupled to the base frame and the chair frame. The gas spring device can selectively incline the inclinable portion of the chair frame to a desired angle with respect to the base frame.

The present invention also provides for a method for making a parallel gas spring, including placing a first gas spring parallel and adjacent to a second gas spring. Each gas spring can have a piston extendably disposed in a cylinder. The first gas spring can be oriented such that the piston in the first gas spring is extendable in the opposite direction of the piston in the second gas spring. The first gas spring can be positioned at a desired longitudinal position with respect to the second gas spring. At least one clamp can be placed around the first and second gas springs. The clamp can be tightened to secure the first and second gas springs together.

### BRIEF DESCRIPTION OF THE DRAWINGS

Features and advantages of the present invention will be apparent from the detailed description that follows, and when taken in conjunction with the accompanying drawings together illustrate, by way of example, features of the invention. It will be readily appreciated that these drawings merely depict representative embodiments of the present invention and are not to be considered limiting of its scope, and that the components of the invention, as generally described and illustrated in the figures herein, could be arranged and designed in a variety of different configurations. Nonetheless, the present invention will be described and explained with additional specificity and detail through the use of the accompanying drawings, in which:

FIG. 1 perspective view of a prior art gas spring device;

FIG. 2 is a side view of an inclinable chair with a prior art gas spring device;

FIG. 3 is a side view of the inclinable chair and gas spring device of FIG. 2, shown with a chair frame in an inclined position;

FIG. 4 is a perspective view of a parallel locking gas spring device in accordance with an embodiment of the present invention, shown with the pistons of gas springs in a compressed configuration;

FIG. 5 is a perspective view of the parallel locking gas spring device of FIG. 4, shown with the pistons of the gas springs in an extended configuration;

FIG. 6 is another perspective view of the parallel locking gas spring device of FIG. 4, shown with the pistons in an extended configuration and the axes of the piston attachment points perpendicular to the plane of the gas springs;

FIG. 7 is another perspective view of the parallel locking gas spring device of FIG. 4, shown with the pistons in an extended configuration and the axes of the piston attachment points orientated parallel to the plane of the gas springs;

FIG. 8 is a perspective view of a parallel locking gas spring device in accordance with another embodiment of the present invention;

FIG. 9 is a rear perspective view of an inclinable chair with a parallel locking gas spring device in accordance with another embodiment of the present invention;

FIG. 10 is a more-detailed rear perspective view of the inclinable chair with a parallel locking gas spring device of FIG. 9;

FIG. 11 is a side view of the inclinable chair of FIG. 9, shown with a chair frame in a relatively higher elevation and in an inclined position;

FIG. 12 is a side view of the inclinable chair of FIG. 9, shown with a chair frame in a relatively lower elevation and in an inclined position;

FIG. 13 is a side view of the inclinable chair of FIG. 9, shown with a parallel locking gas spring device having a pair of gas springs positioned in a lengthened relationship to one another;

FIG. 14 is a side view of the inclinable chair of FIG. 9, shown with a parallel locking gas spring device having a pair of gas springs positioned in a lengthened relationship to one another and in a forward tilted position;

FIG. 15 is a side view of the inclinable chair of FIG. 9, shown with a parallel locking gas spring device having a pair of gas springs positioned in a shortened relationship to one another;

FIG. 16 is a side view of the inclinable chair of FIG. 9, shown with a parallel locking gas spring device having a pair of gas springs positioned in a shortened relationship to one another and in a rearward tilted position;

FIG. 17 is a side view of the inclinable chair of FIG. 9, shown with a parallel locking gas spring device having a pair of gas springs with each of the gas springs having a different spring force;

FIG. 18 is a side view of the inclinable chair of FIG. 9, shown with a parallel locking gas spring device having a pair of gas springs with each of the gas springs having a different spring force and with a higher force gas spring in an extended position and a lower force gas spring in a compressed position;

FIG. 19 is a side view of the inclinable chair of FIG. 9, shown with a parallel locking gas spring device having a pair of gas springs with each of the gas springs having a different spring force and with the lower force gas spring in an extended position and the higher force gas spring in a compressed position;

FIG. 20 is a side view of the inclinable chair of FIG. 9, shown with a parallel locking gas spring device having a pair of gas springs with one of the gas springs being a locking gas spring and the other being a non-locking gas spring;

FIG. 21 is a rear perspective view of an inclinable chair with a parallel locking gas spring device in accordance with another embodiment of the present invention, the chair shown with a plurality of inclinable portions;

FIG. 22 is a side view of the inclinable chair of FIG. 21;

FIG. 23 is a front perspective view of an inclinable chair with a parallel locking gas spring device in accordance with yet another embodiment of the present invention, the locking mechanisms being can be rotated 90 degrees and aligned out-of-plane with the plane of the first and second gas springs,

FIG. 24 is a side view of an inclinable chair with a parallel locking gas spring device in accordance with yet another embodiment of the present invention; and

FIG. 25 is a flowchart depicting a method of making a parallel locking gas spring device in accordance with another embodiment of the present invention.

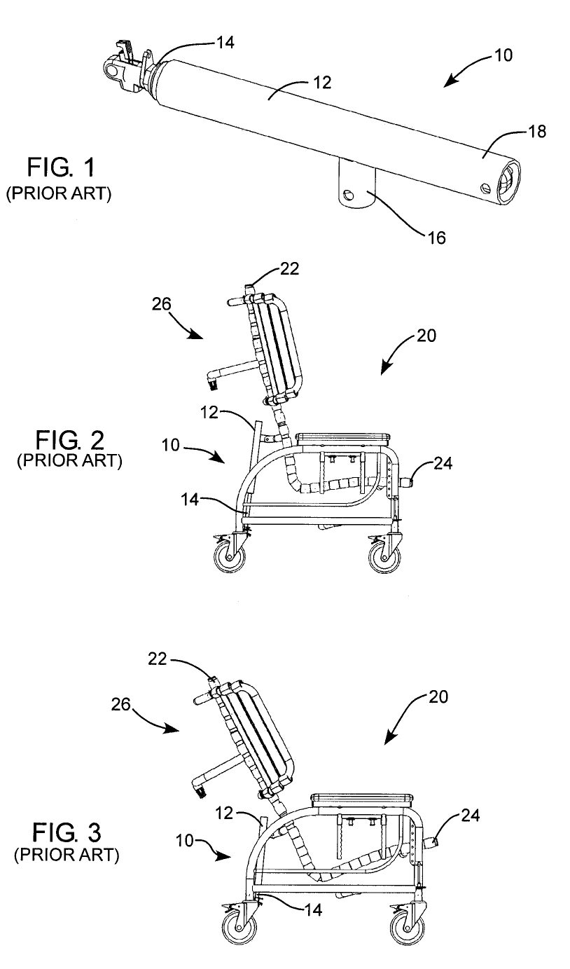

### DETAILED DESCRIPTION

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments and to sufficiently enable one skilled in the art to practice the invention. Accordingly, the scope of the present invention is to be defined solely by the appended claims.

The embodiments of the present invention provide generally for a chair with a reclining or inclining portion that can be inclined to a desired selected angle by a parallel locking gas spring device. The chair can include a base frame that can be placed on a support surface. A chair frame, consisting of a backrest, and a seat can be movably coupled to the frame. In one aspect, the entire chair frame can pivot simultaneously between a forward inclined position and a rearward inclined position with respect to the base frame. In another aspect, the backrest of the chair frame can pivot with respect to the seat between a forward inclined position and a rearward inclined position. It will be appreciated that other inclining portions, such as an inclinable leg rest, can also be coupled to the chair frame and can incline with respect to the chair frame and/or the base frame.

The parallel locking gas spring device can be coupled between the inclinable portion and the base frame. The parallel locking gas spring device can include a first locking gas spring with a piston disposed in a cylinder and extendable therefrom. A second locking gas spring can be positioned parallel and adjacent to the first locking gas spring. The second locking gas spring can include a piston disposed in a cylinder. The piston in the second locking gas spring can extend from the cylinder opposite the direction of the piston in the first cylinder. The piston in the first locking gas spring can be coupled to one of the chair frame or the base frame, and the piston in the second locking gas spring can be coupled to the other of the chair frame or the base frame. In this way the inclinable portion of the chair frame can be inclined in one direction by compressing one or both of the pistons of the locking gas spring device and, similarly, the inclinable portion of the chair frame can be inclined in an opposite direction by extending one or both of the pistons in the locking gas spring device.

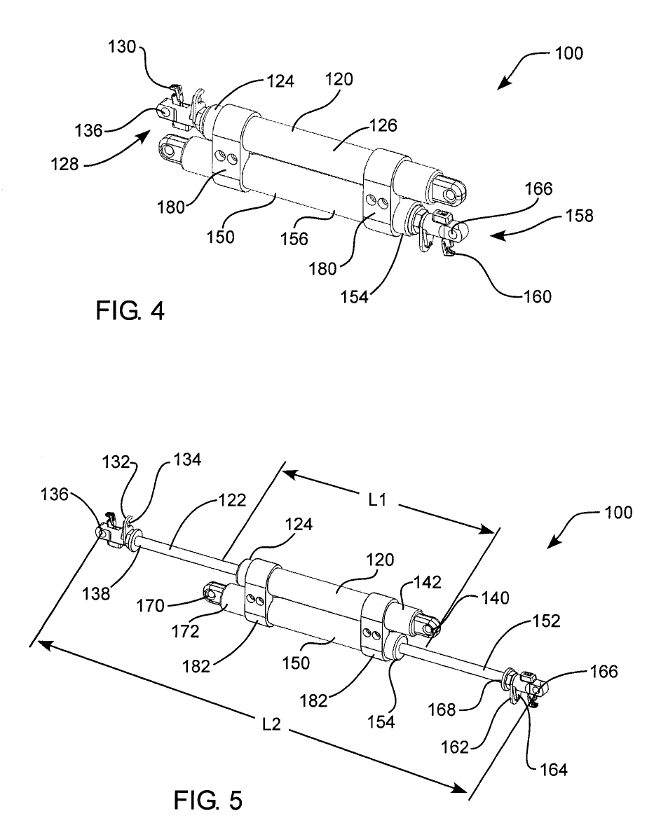

As illustrated in FIGS. 4-5, a parallel locking gas spring device, indicated generally at 100, is shown in accordance with an embodiment of the present invention. The parallel locking gas spring device 100 can be used in any application where a variably adjustable or telescoping length member is needed. Advantageously, because the parallel locking gas spring device 100 is self-contained and needs no supporting structure to maintain the positioning of the opposing gas springs, the gas spring device 100 can also be used in any application where the variably adjustable length member can be positioned at or moved through a variably adjustable angle as the parallel locking gas spring device is moved through a complete compression-extension duty cycle. As will be described in more detail below, the parallel locking gas spring device 100 can be used to recline or incline portions of a chair.

The parallel locking gas spring device 100 can include a first gas spring 120, a second gas spring 150 and an adjustable coupling, indicated generally at 180, that can couple the first gas spring 120 to the second gas spring 150. Together, the first gas spring 120 and the second gas spring 150 can form a pair of opposing gas springs.

The first gas spring 120 can include a first piston having a piston rod 122 extendible from a proximal end 124 of a first cylinder 126. The first piston rod 122 can be compressed into the first cylinder 126 to a compressed position, as shown in FIG. 4, and pulled or extended out of the first cylinder to an extended position, as shown in FIG. 5. The first piston rod 122 can also be selectively and adjustably positioned at any intermediate position between the extended position and the compressed position.

The first gas spring 120 can also include a locking mechanism, indicated generally at 128. The locking mechanism 128 can lock the first piston rod 122 in either the extended position or the compressed position or in any position between the extended compressed positions. The locking mechanism 128 can include an actuator such as a locking lever 130 that can be positioned on piston rod 122. The locking lever 130 can pivot to engage or disengage an internal lock in the first cylinder 126, such as an internal valve (not shown) that hydraulically secures the position of the piston anywhere mid-stroke, and not just in the extended position. When engaged, the internal lock can secure the first piston rod 122 from movement within the first cylinder 126. When disengaged, the piston can slide into or out of the cylinder between the compressed position and the extended position.

The locking mechanism 128 can include fittings 132 and 134 for an actuation device such as a Bowden cable, which cable can extend to a handle at a remote location away from the first gas spring 120 and allow remote actuation of the locking mechanism 128 from the remote location. In one aspect, the locking lever 130 and fittings 132, 134 of the locking mechanism can be positioned and oriented to be accessible from an in-plane, outside direction or a direction opposite the second gas spring 150, as shown in FIGS. 4-5. In another aspect, the locking mechanism can be positioned and oriented to be accessible from an in-plane, inside direction, or from between the first and second gas springs (not shown).

The first gas spring 120 can include a piston attachment point 136 disposed on a distal end 138 of the first piston rod 122. Additionally, the first gas spring 120 can also include a cylinder attachment point 140 disposed on a distal end 142 of the first cylinder 126. The first gas spring attachment points 136 and 140 can pivotally couple the first gas spring 120 to either of the fixed or moving structures of an application device.

The second gas spring 150 can be similar in many respects to the first gas spring 120 and can include a second piston with a piston rod 152 extendible from a proximal end 154 of a second cylinder 156. The second piston rod 152 can be compressed into the second cylinder 156 to a compressed position, as shown in FIG. 4, and pulled or extended out of the second cylinder to an extended position, as shown in FIG. 5. The second piston rod 152 can also be selectively and adjustably positioned at any intermediate position between the extended position and the compressed position.

The second gas spring 150 can be disposed parallel and adjacent to the first gas spring 120. Additionally, the second gas spring 150 can be oriented such that the second piston rod 152 can be extendible from the second cylinder 156 in an opposite direction from the first piston rod 122.

The second gas spring 150 can also include a locking mechanism, indicated generally at 158. The locking mechanism 158 can lock the second piston rod 152 in either the extended position or the compressed position or in any position between the extended compressed positions. The locking mechanism 158 can include an actuator such as a locking lever 160 that can be positioned on the second piston rod 152. The locking lever 160 can be pivoted to engage or disengage an internal lock (not shown) in the first cylinder 156. When engaged, the internal lock can secure the first piston rod 152 from movement within the first cylinder 156. When disengaged, the piston can slide into or out of the cylinder between the compressed position and the extended position.

The locking mechanism 158 can include fittings 162 and 164 for an actuation device such as a Bowden cable, which cable can extend to a handle at a remote location away from the second gas spring 150 and allow remote actuation of the locking mechanism 158 from the remote location. It will be appreciated that the cable from the first gas spring and the cable from the second gas spring can be coupled to a single handle such that both gas springs can be actuated by a single handle. Additionally, the cable from the first gas spring and the cable from the second gas spring can each be coupled to a different handle such that each of the gas springs is actuated by a different handle.

In one aspect, the locking lever 160 and fittings 162, 164 of the locking mechanism 158 can be positioned and oriented to be accessible from an in-plane outside direction, or from a direction opposite the first gas spring 120, as shown in FIGS. 4-5. In another aspect, the locking mechanism can be positioned and oriented to be accessible from an in-plane inside direction, or from between the first gas spring 120 and second gas spring 150 (not shown).

The second gas spring 150 can also include a piston attachment point 166 disposed on a distal end 168 of the second piston rod 152. Additionally, the second gas spring 150 can also include a cylinder point 170 disposed on a distal end 172 of the second cylinder 156. The second gas spring attachment points 166 and 170 can pivotally couple the second gas spring 150 to either of the fixed or moving structures of an application device.

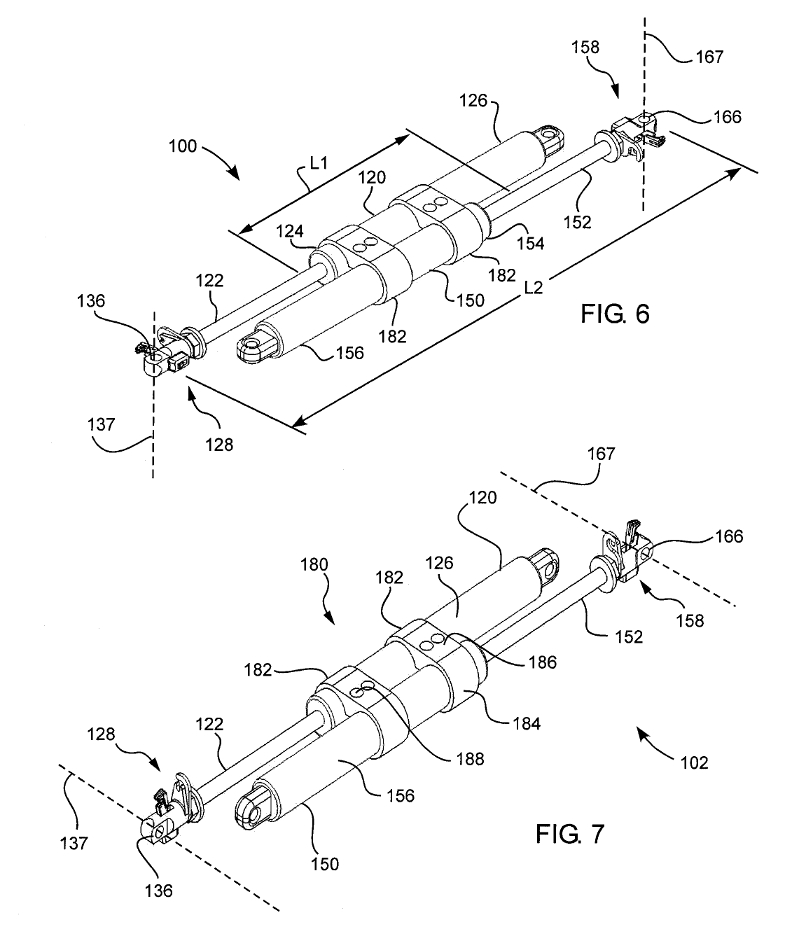

As discussed hereinabove and illustrated with greater detail in FIG. 6, the locking mechanisms 128, 158 located at the distal ends of piston rods 122, 152 can be aligned in-plane with the plane of the first 120 and second 150 gas springs, so that the axes 137, 167 of the piston attachment points 136, 166 are perpendicular to the plane of the gas springs. However, in another aspect of the parallel locking gas spring device 102 shown in FIG. 7, the locking mechanisms 128, 158 located at the distal ends of piston rods 122, 152 can be rotated 90 degrees and aligned out-of-plane with the plane of the first 120 and second 150 gas springs, so that the axes 137, 167 of the piston attachment points 136, 166 are now parallel to the plane of the gas springs. This can be advantageous in situations where a heavy load is applied to the gas spring device 102, so that any bending moments resulting from the offset distance between the first 120 and second 150 gas springs are carried by the adjustable coupling 180, and not by the rods and sliding end-seals in the gas springs.

As further shown in FIG. 7, the adjustable coupling 180 can comprise one or more clamps 182 sized and shaped to enclose and secure the first cylinder 126 and the second cylinder 156, and to reduce or eliminate rotation of the first gas spring 120 with respect to the second gas spring 150. The clamp 182 can comprise an adjustable one-piece clamp ring 184 with an adjustable portion 186 which can be tighted or loosend with clamp screws 188. The adjustable portion 186 can be loosened by releasing the clamp screws 188 such that the clamp 182 can be re-positioned along the longitudinal lengths of the first cylinder 126 and the second cylinder 156, and re-tighted to secure the two cylinders together. Alternatively, each clamp can be comprised of a multi-piece assembly including a clamping ring and a cover, with the cover removably coupled to the clamping ring to enclose the first and second gas springs by threaded fasteners such as bolts, screws or the like.

Referring back to FIG. 5 and FIG. 6, the clamps 182 can adjustably position the first cylinder 126 along the longitudinal length of the second cylinder 156 to define a combined cylinder-to-cylinder length L1 (e.g. the length of the parallel locking gas spring device with the piston rods 122, 152 in the compressed positions). The overall piston-to-piston length can be defined as L2 (e.g. the length of the parallel locking gas spring device with the piston rods 122, 152 in the extended positions). Advantageously, because the clamps can be positioned anywhere along the longitudinal length of the first or second cylinders, both the combined cylinder-to-cylinder length L1 and the overall piston-to-piston length L2 can be adjusted.

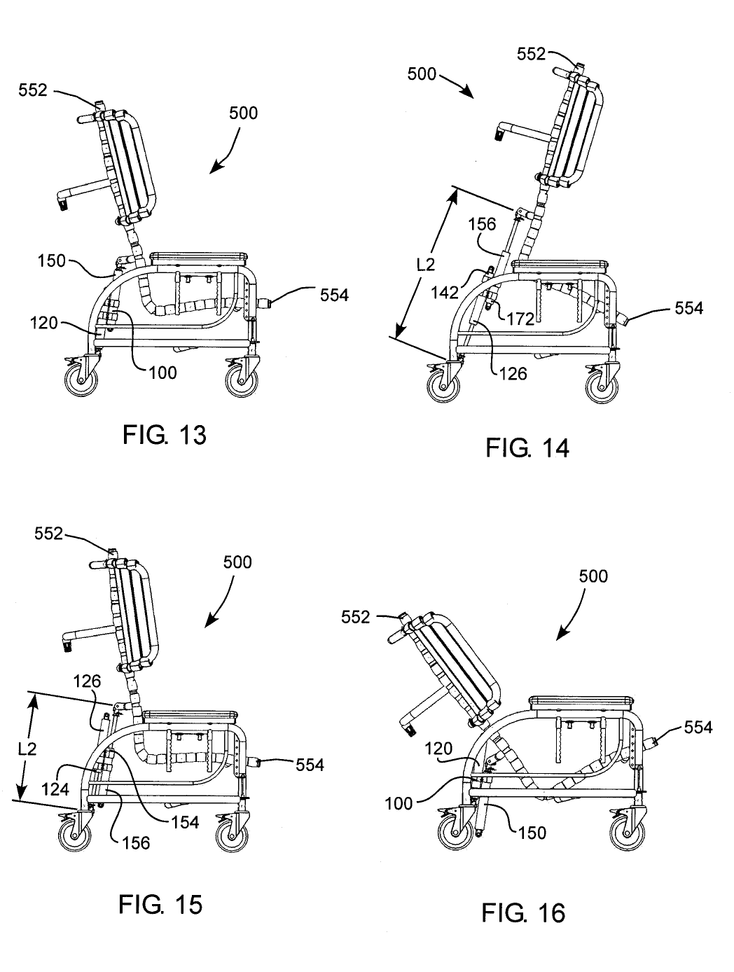

For example, as shown in FIG. 5 the first gas spring 120 and the second gas spring 150 can be positioned substantially side-by-side and the clamps 182 located near the approximate ends of both the first and second cylinders. Alternatively, as shown in FIG. 6, the first and second gas springs can be positioned in an offset end-to-end position with the proximal ends 124, 154 of both cylinders placed closer together. This has the effect of reducing the combined cylinder-to-cylinder length L1 of the parallel locking gas spring device in the compressed position as well as reducing the overall piston-to-piston length L2 in the extended position. In yet another alternative configuration (see FIGS. 13-14) the first and second cylinders can be positioned in an offset end-to-end position with the distal ends 142, 172 of both cylinders 126, 156 placed closer together, which can have the effect of increasing both the combined cylinder-to-cylinder length L1 and the overall piston-to-piston length L2.

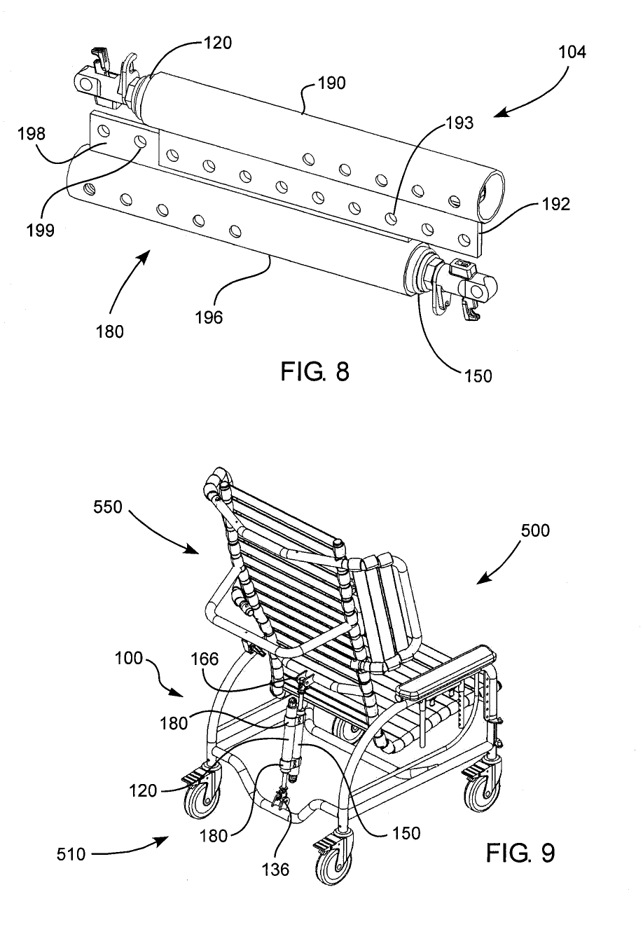

The clamps 182 forming the adjustable coupling 180 are one means for joining the first gas spring 120 and the second gas spring 150. Other means for joining the two gas springs can also be used. For example, as shown in FIG. 8, a gas spring device, indicated generally at 104, is shown that is similar in many respects to the gas spring device 100 described above and shown in FIGS. 4-7, with the exception that the first gas spring 120 and the second gas spring 150 can be coupled together by a pair of holed flanges 192, 198 coupled to sleeves 190, 196 covering the gas springs.

Thus, in one aspect, the first gas spring 120 can be covered by a first sleeve 190 having a first holed elongated flange 192 extending from the first sleeve. Similarly, a second holed elongated flange 198 can extending from a second sleeve 196 covering the second gas spring 150. The holes 193 of the first flange 192 can be selectively alignable with the holes 199 in the second flange 198 in order to adjust the overall piston-to piston length of the gas spring device 104. At least one fastener (not shown), such as a bolt, screw, or the like, can be disposed through the aligned holes 193 and 199 in order to couple the first flange 192 to the second flanges 198, and hence the first and second gas springs together. Thus, the holed flanges are another means 180 for adjustably joining the two gas springs.

With the first 120 and the second 150 gas springs coupled together by the adjustable coupling 180, the piston attachment points 136 and 166 on each of the distal ends of the first and second pistons can pivotally couple the parallel locking gas spring device 100 between the fixed and movable structures of an application device, such as between the fixed base 510 and the movable seat 550 of the inclinable chair 500 shown in FIG. 9. For example, piston attachment point 136 can be coupled to the base portion 510 of the chair, and piston attachment point 166 can be coupled to the reclining or inclining portions 550 of the chair 500. Advantageously, the piston attachment points 136 and 166 along with the adjustable and extendable pistons 120 and 150 can allow the gas spring device 100 to be variably adjusted in both length and angle such that as the moving structure of the application device moves, the gas spring device 100 can extend or compress as needed and also pivot through a range of angles as needed.

It will be appreciated that the parallel locking gas spring device can be configured to meet desired application needs. Hence, it is a particular advantage that the adjustable coupling can position the first and second gas springs at a variety of lengths such that the overall piston-to-piston length can be set to a length that is needed for a particular application. Additionally, it will be appreciated that the locking gas springs have a particular resistive or spring force. Thus, different springs having greater or lesser spring forces can be used according to desires and requirements of the particular application. Moreover, gas springs having different spring forces can be used for each of the first and second gas springs such that the first gas spring can have one spring force and the second gas spring can have a different spring force than the first gas spring. In this way, the parallel locking gas spring device can be tailored by the end-user to meet desired application requirements.

The parallel locking gas spring device of the present invention have several other commercial and technical advantages. For example, as mentioned above, the adjustability of the position of each of the springs in relation to the position of the other gas spring can result in a significantly greater piston-to-piston stroke in a more compact compressed package. Additionally, the orientation and positioning of the gas springs 120 and 150 in relation to one another results in little to no interfering protrusion behind the mounting points of the gas springs. Furthermore, the adjustable coupling 180 can provide the ability to adjust and modify the overall length of the device as desired or needed by particular application. Still further, the adjustable coupling can provide the possibility of using gas springs having different properties, such as spring force or different actuation methods, in order to create extension stages having varying characteristics. Moreover, since the adjustable coupling does not modify the original gas springs, relatively low cost, readily accessible and commercially available locking gas springs can be used with the adjustable couplings to form the parallel locking gas spring devices described herein.

An additional advantage of the parallel locking gas spring device is the ability to apply more than one gas spring to an application or a location that traditionally only permits one gas spring to be used. The use of more than one gas spring increases the ratio between the overall extended length of the assembly and its overall collapsed length. Being able to achieve a shorter effective collapsed length and a longer overall extended length allows for a greater range of movement.

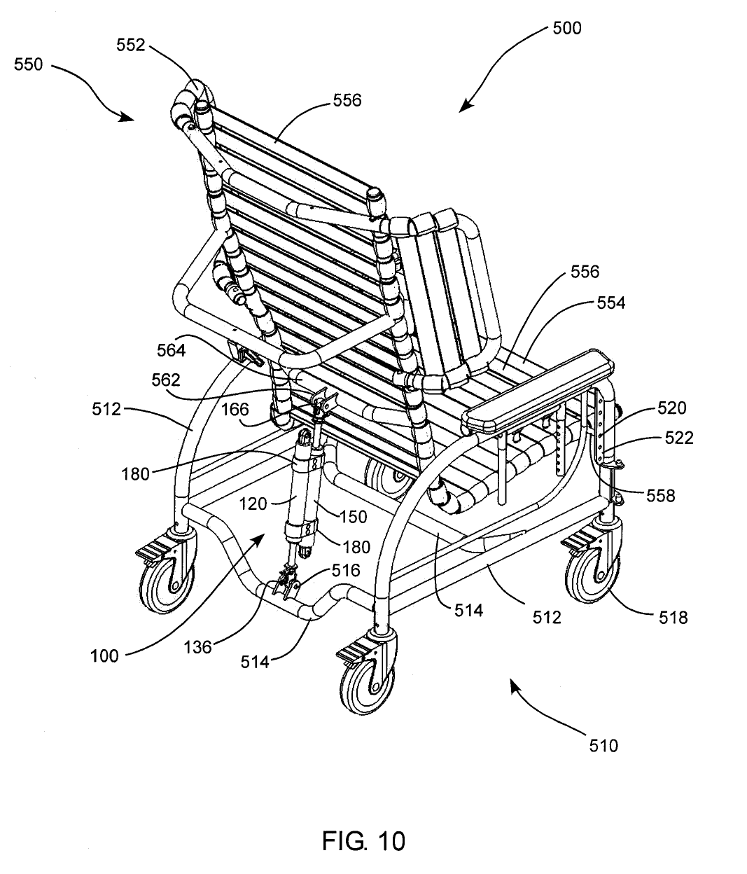

As described above, the parallel locking gas spring device can be used to move and position movable portions of various structures such as chairs, as shown in FIGS. 10-27, and described below.

Turning to FIG. 10, an inclinable chair, indicated generally at 500 including an adjustable parallel locking gas spring device 100 is shown with greater detail. The inclinable chair can include a base frame, indicated generally at 510 and a chair frame, indicated generally at 550, movably coupled to the base frame. The parallel locking gas spring device 100 can be coupled between the base frame and the chair frame and can move the chair frame in relation to the base frame by releasing the internal locking mechanisms located inside the cylinders, as described above.

The base frame 510 can be formed by shaped tubing and can include two side frames 512 joined together by cross members 514. The rear-most cross member can include a pivot fitting 516 that can be used to pivotally couple the piston attachment point 136 of the first piston 120 to the base frame 510. In one aspect, the fitting 516 can be positioned at a substantially central location along the rear cross member 514 so as to position the gas spring device 100 in a substantial center region of the chair 500.

The side frames 512 can be configured to rest upon a support surface. In one aspect, the side frames 512 can include feet (not shown) that can carry the chair on the support surface. In another aspect, the side frames 512 can include wheels 518. The wheels 518 can allow easy movement of the chair 500 even when occupied by a user.

The chair frame 550 can also be formed by shaped tubing and can include a backrest portion 552 and a seat portion 554. The backrest portion 552 and seat portion 554 can have an occupant support surface 556, such as plastic straps or an upholstery cover (not shown).

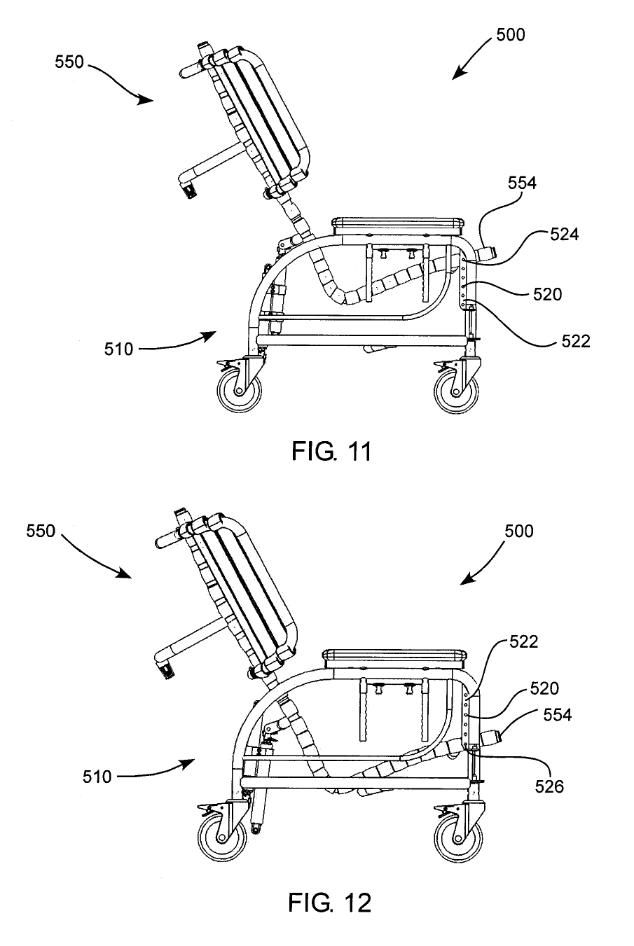

The chair frame 550 can be movably coupled and supported by the base frame 510. For example, the front portion of the chair frame 550 can include a pair of front pivot pins 558 disposed on either side of the chair frame 550. The pivot pins 558 can be positioned in pivot holes 520 formed in a holed flange 522 extending from a front member of the base frame 510. As shown in more detail in FIGS. 11 and 12, the pivot pins 558 can be positioned in a hole 520 in the holed flange 522 according to a desired height of the seat portion 554 of the chair frame 550. Thus, as shown in FIG. 11, the pivot pins 558 can be positioned in an upper hole 524 to raise the position of the seat portion 554 of the chair frame 550. Similarly, as shown in FIG. 12, the pivot pins 558 can be positioned in a lower hole 526 to lower the position of the seat portion 554 of the chair frame 550. It will be appreciated that the seat portion 554 can be moved as desired to accommodate the size and leg length of the occupant of the chair 500.

Referring back to FIG. 10, the back portion of the chair frame 550 can be supported by the parallel locking gas spring device 100. For instance, the pivot attachment point 166 of the second cylinder 150 can be coupled to fitting 562 extending from cross member 564, which cross member 564 in turn connects to the backrest portion 552 of the chair frame 550. The fitting 562 can correspond in lateral location to the fitting 516 on the base frame 510. Thus, in one aspect, the fitting 562 can be located in a central location on the cross member 564 of the backrest 552 and the gas spring device 100 can be substantially centrally located laterally along the chair 500. Having the gas spring device 100 centrally located along the back of the chair can equalize the loading on the gas spring device 100 and reduce any torsional moments as might be experienced if the spring device 100 were located towards either the side of the chair 500. In an alternative embodiment, however, one or more suitably-sized gas spring devices may also be placed along the side of the chair if desired.

As noted above, the gas spring device 100 can be coupled between the cross member 564 of the chair frame 550 and the cross member 514 of the base frame 510 to provide the chair with a reclinable or inclinable portion. Furthermore, since the gas spring device 100 can include a first gas spring 120 coupled to a second gas spring 150 by an adjustable clamp 180, all of the adjustability of the gas spring device 100 as described above can be utilized by the inclinable chair 500. For example, the adjustability of the gas spring device 100 can provide the ability to accommodate changes in seating geometry of the chair 500 without significantly compromising the seating range of motion, or the need for additional hardware. Using seat tilt as an example, if the height of the chair seat 554 is raised from a lower position, the relative position of the two gas springs 120 and 150 in the gas spring device (e.g. the cylinder-to-cylinder length as described above) can be adjusted so that the overall length is increased appropriately to maintain a consistent overall seating geometry, such as to maintain the unloaded chair seat 554 in a level position.

The inclinable portions of the chair 500 can include a variety of sections of the chair frame 550. For example, as shown in FIGS. 10-20, the entire chair frame 550 can be rigidly connected together and configured for rotational movement about the pivot pins 558 in response to movement of the piston rods in and out of the cylinders of the gas spring device 100. Alternatively, other portions of the chair frame can also be reclinable or inclinable with respect to the base frame. For example, in one aspect the backrest can incline with respect to the seat. Similarly, the seat can be inclined with respect to the base frame and backrest. Additionally, the chair frame can include a leg rest that can be inclined with respect to the seat. It is to be appreciated that each of these inclinable portions can be supported and coupled to the other components by the parallel locking gas spring 100 described above.

It will also be appreciated that many of the advantages of the parallel locking gas spring device 100 described above can be applied to the inclinable chair 500. For example, as shown in FIGS. 13-14, the first gas spring 120 can be positioned in relation to the second gas spring 150 such that the distal end 142 of the first cylinder 126 is closer to the distal end 172 of the second cylinder 156. In this configuration, the overall piston-to-piston length L2 of the gas spring device is longer than if the first and second gas springs are positioned with the ends aligned with one another. Additionally, this long configuration allows the chair frame to be tilted into a forward position with the seat 554 sloping downwardly from the backrest 552 to the front of the chair frame.

Additionally, as seen in FIGS. 15-16, the first gas spring 120 can be positioned in relation to the second gas spring 150 such that the proximal end 124 of the first cylinder 126 is closer to the proximal end 154 of the second cylinder 156. In this configuration the overall piston-to-piston length L2 of the gas spring device 100 is shorter than if the first and second gas springs are positioned with the ends aligned with one another. This short configuration allows the chair frame to be tilted into a more reclined position, with the seat 554 sloping downwardly and rearwardly from the front of the chair 410 to the backrest 552.

Thus, it is a particular another advantage of the embodiments of the inclinable chair 500 of the present invention that the relative location of the two gas springs 120 and 150 can be adjusted (i.e., brought closer together or further apart). This enables the end user to freely create chair configurations where the limits of motion are constrained in a desired range. In the case of seat tilt, the gas spring device 100 can be configured such that posterior or rearward tilt is maximized and anterior or forward tilt is minimized. Similarly, the position of the two gas springs 120 and 150 can also be positionally adjusted to a point where the posterior tilt is minimized and anterior tilt is maximized.

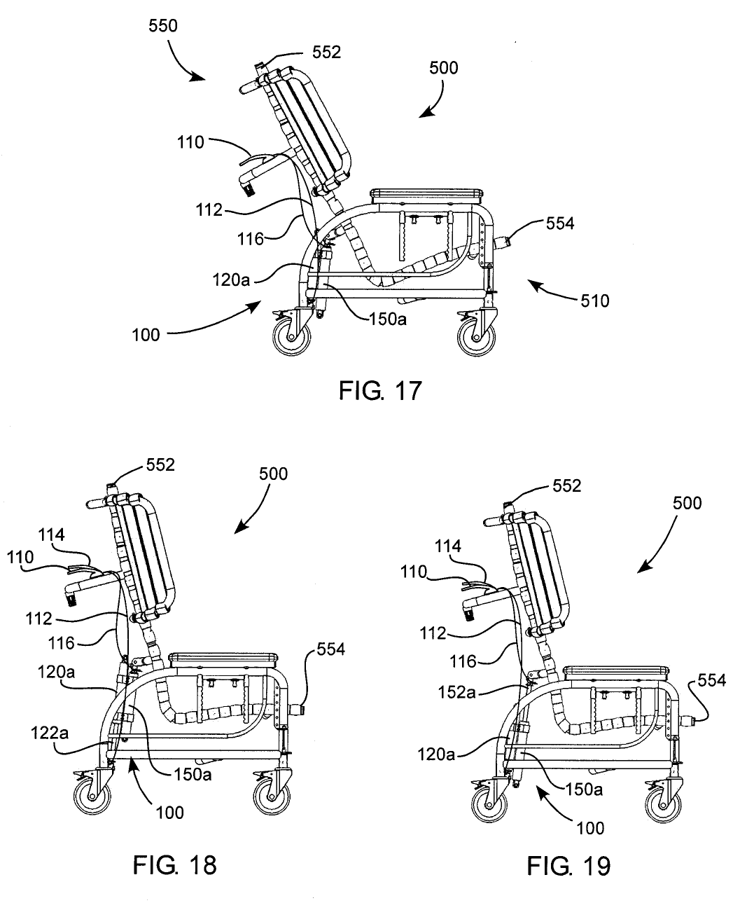

As illustrated in FIGS. 17-19, the first gas spring device 120a can have a higher spring force than the second gas spring 150a. Additionally, the first gas spring 120a can be actuated into the extended position independently from the second gas spring 150a. The first gas spring 120a can be operated with an actuation device such as a Bowden cable 112, which cable can attach to the fittings and locking lever located on the distal end of the first piston rod, as described hereinabove, and can extend to a handle 110 located at a remote location away from the first gas spring 120, allowing for actuation of the first piston's locking mechanism from the remote location.

Similarly, the second gas spring 150a can be operated with an actuation device such as a Bowden cable 116, which cable can attach to the fittings and locking lever located on the distal end of the second piston rod, as described hereinabove, and can extend to a handle 114 located at a remote location away from the second gas spring 150, also allowing for actuation of the second piston's locking mechanism from the remote location. As illustrated in FIGS. 18-19, the cable 112 from the first gas spring and the cable 116 from the second gas spring can each be coupled to the separate handles 110, 114 such that each gas spring is actuated by a different handle. As shown in FIG. 17, however, that the cables 112, 116 can also be coupled to a single handle 110 such that both gas springs can be simultaneously actuated by a single handle.

Referring now to FIG. 18, with the independent operation of each gas spring 120a, 150a, the piston rod 122a of the first gas spring can be actuated to the extended position while the piston rod 152a of the second gas spring 150a is locked in the compressed position. Similarly, as seen in FIG. 19, the piston rod 152a of the second gas spring 150a can be actuated to the extended position while the piston rod 122a of the first gas spring 122a is locked in the compressed position. In addition to each gas spring being independently operable, the two gas springs can be advantageously configured with different functional properties. Consequently, the two gas springs with different properties can be used in the same gas spring device 100 without altering the overall design of the chair 500.

This capability can provide several advantages to the user of the chair 500. For example, when tilting the seat 552 for a smaller lighter occupant it is advantageous to use a gas spring that provides a lower counter balancing force as this minimizes any downward pushing that the caregiver must exert. Conversely, when tilting the seat 552 for a larger, heavier occupant it is beneficial to have a gas spring that provides a higher counter balancing force to reduce any upward pulling necessary by the caregiver. Using the parallel locking gas spring 100 of the present invention can allow both a low force and a high force gas spring to be mounted to the chair 500 and selectively activated by the caregiver by two separate cables 112, 116 in response to whether a light or heavy person will be sitting in the chair. Since both gas springs are located and mounted in the same general position, the overall seating geometry and the amount of available seat tilt is not altered.

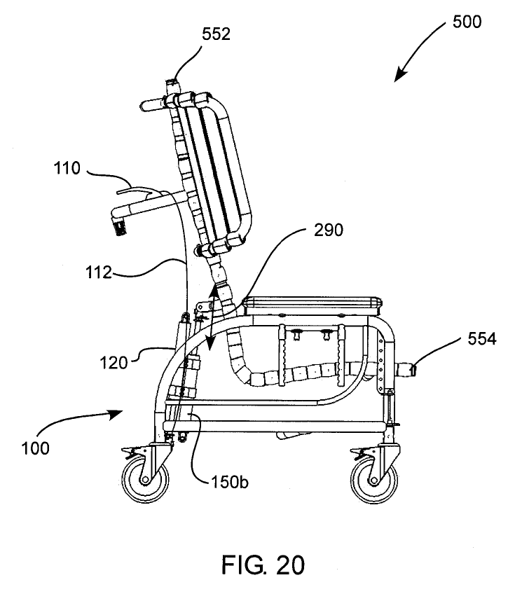

Having two gas springs of different properties can be further advantageous in situations where the different gas spring properties need to be exhibited simultaneously and superimposed over one another. For example, as illustrated in FIG. 20, in an application where there is a need for a high degree of seat tilt compliance (i.e., bounce) but also control over the tilt angle of the seat, the gas spring device 100 can be configured to allow both a rigid locking gas spring 120 to be used as the first gas spring and a non-locking non-dampening gas spring 150b to be used as the second gas spring. The locking gas spring 120 can allow the overall seat angle to be manipulated and controlled with handle 110 and cable 112, while the non-locking gas spring 150b allows the seat to “bounce”, as indicated by arrow 290, within the non-locking gas spring's 150b stroke limits. Typically a chair that can bounce would be used for occupants that require a high level of care and exhibit agitated behaviors. Advantageously, the constant bouncing motion provides a therapeutic calming effect, and the seat tilt provides positioning.

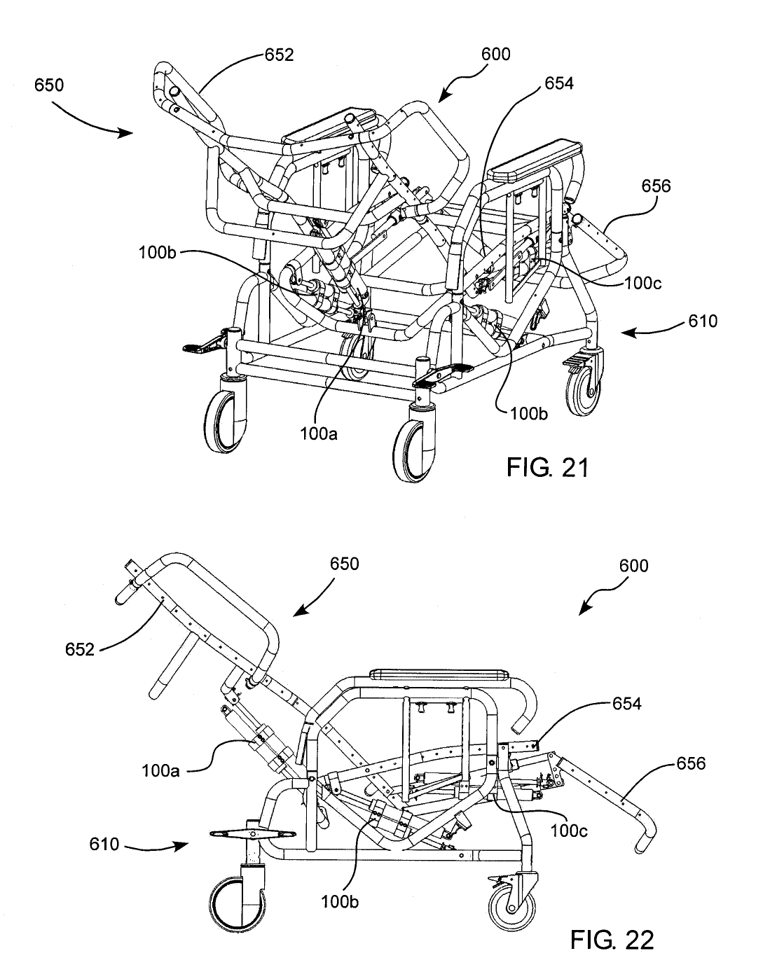

Illustrated in FIGS. 21-22 is another representative embodiment of an inclinable chair, indicated generally at 600, which includes a plurality of adjustable parallel locking gas spring devices described above. The inclinable chair 600 can have a base frame, indicated generally at 610, and a chair frame, indicated generally at 650. The chair frame 650 can have multiple reclining or inclining portions and each inclining portion can be selectively inclined via a parallel locking gas spring device.

For example, the chair frame 650 can have a backrest 652 that can be inclined with respect to the seat 654 and the base frame 610. A gas spring device 100a can be coupled between the backrest 652 and the base frame 610 to allow the backrest 652 to be inclined and locked into a desired angle of inclination with respect to the base frame.

Additionally, the chair frame 650 can have a seat 654 that can also be inclined with respect to the base frame 610. A pair of gas spring devices 100b can be disposed on either side of the seat 654 and coupled to the seat 654 and the base frame 610 to allow the seat 654 to be inclined and locked into a desired angle of inclination with respect to the base frame 610.

Finally, the chair frame 650 can include a leg rest 656 that can be also inclined with respect to the seat 654. A gas spring device 100c can be disposed on one side of the seat 654 and leg rest 656 and coupled between the seat 654 and leg rest 656 to allow the leg rest to be inclined and locked into a desired angle of inclination with respect to the seat 654 and base frame 610.

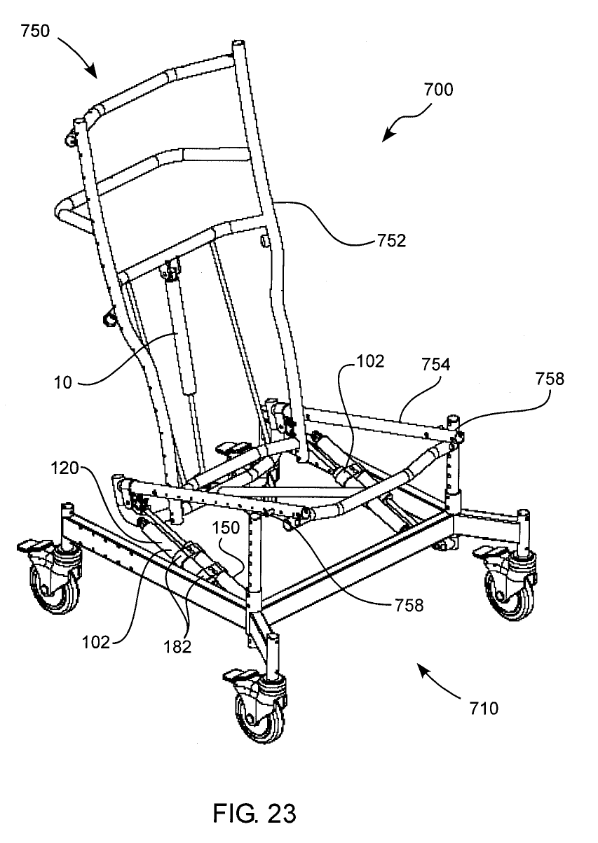

Illustrated in FIG. 23 is yet another representative embodiment of a inclinable chair, indicated generally at 700, which includes a plurality of adjustable parallel locking gas spring devices described above in combination with a more traditional single-cylinder gas spring device. The “hybrid” embodiment of the inclinable chair 700 can have a base frame, indicated generally at 710, and a chair frame, indicated generally at 750. The chair frame 750 can have multiple reclining or inclining portions and each inclining portion can be selectively inclined via a parallel locking gas spring device or a single-cylinder gas spring device.

For instance, the chair frame 750 can have a seat 754 that can be inclined with respect to the base frame 710. A pair of parallel locking gas spring devices 102 can be disposed on either side of the seat 754 and coupled to the seat 754 and the base frame 710 to allow the seat 754 to be inclined and locked into a desired angle of inclination with respect to the base frame 710. As discussed hereinabove, the locking mechanisms located at the distal ends of the piston rods of the gas spring devices 102 can be rotated 90 degrees and aligned out-of-plane with the plane of the first 120 and second 150 gas springs, so that the axes of the piston attachment points are parallel to the plane of the gas springs (e.g. horizontal as shown in FIG. 23). This can be advantageous in situations where a heavy load is applied to the gas spring device 102, such as when the chair frame 750 is supported on both sides by a pivot pin 758 and a parallel locking gas spring device 102 extending primarily in the horizontal direction underneath the seat. As a result, any bending moment resulting from the offset distance between the first 120 and second 150 gas springs can be carried by the adjustable couplings 182, and not by the rods and sliding end-seals in the gas springs.

In the representative embodiment shown in FIG. 23, moreover, the chair frame 750 can have a backrest 752 that can be inclined with respect to the seat 754 with a traditional single-cylinder gas spring 10 which can be coupled between the backrest 752 and the base frame 710 to allow the backrest 752 to be inclined and locked into a desired angle of inclination with respect to the base frame. Thus, it is to be appreciated that dual-cylinder parallel locking gas spring devices 100, 102, etc. can be combined with the traditional single-cylinder gas springs 10 in a wide variety of configurations to best meet the needs of the designer of the inclinable chair.

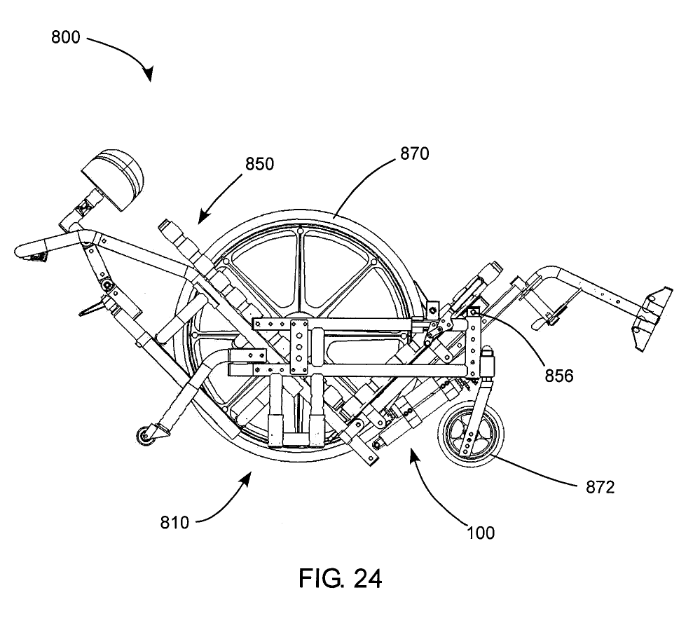

Illustrated in FIG. 24 is yet another representative embodiment of an inclinable chair 800 which can function as a standard reclinable or inclinable wheelchair, and which can include also one or more adjustable parallel locking gas spring devices 100 as described above. The inclinable chair can have a base frame 810, a chair frame 850, a pair of large drive wheels 870 and a pair of smaller guide wheels 872. The large drive wheels 870 can be grasped and turned by the occupant of the chair to propel the chair forward or backward. Additionally, the chair frame 850 can have reclining or inclining portions that can be selectively inclined via a parallel locking gas spring device 100 to recline the occupant of the wheelchair.

As mentioned above, since two gas springs are used with the gas spring device 100, each of the gas springs 120 and/or 150 can be chosen such that their functional properties are different. The inclinable wheel chair 800 is yet another example of where this is useful, since the gas spring position, chair geometry, and the position of the occupant's center of gravity may require a very high force from a gas spring to lift the seat out of tilt. For instance, it will be appreciated that due to the steep seat tilt angle of the chair frame 850 of the wheelchair 800, the occupant's center of gravity is far away from the chair frame pivot 856, and the normal distance from the gas spring axis to the seat pivot is very short, thereby offering very little mechanical advantage.

In this situation a high force gas spring is desired and may be required in order to provide sufficient counterbalancing force to bring the chair frame 850 out of tilt. However, as the chair frame 850 is lifted and approaches a horizontal position the mechanical advantage offered by the gas spring increases and the normal distance from the occupant's center of gravity force vector is brought closer to the chair frame pivot 856, hence requiring less force from the gas springs to lift the same occupant. If a constant force gas spring is used in this situation, there is a risk that there will be too little lifting force in the fully tilted position or conversely to too much lifting force near the horizontal seating position. Advantageously, by using the gas spring device 100 described generally herein, and selecting two gas springs of different force, the lower tilt range can be serviced by the stronger gas spring and the upper tilt range can be supported by the weaker gas spring. Thus, the dual gas spring force of the gas spring device 100 can minimize the effect for any fluctuating counterbalancing force requirements due to shifts in center of gravity or mechanical advantage as the chair frame 850 is tilted through its range of motion.

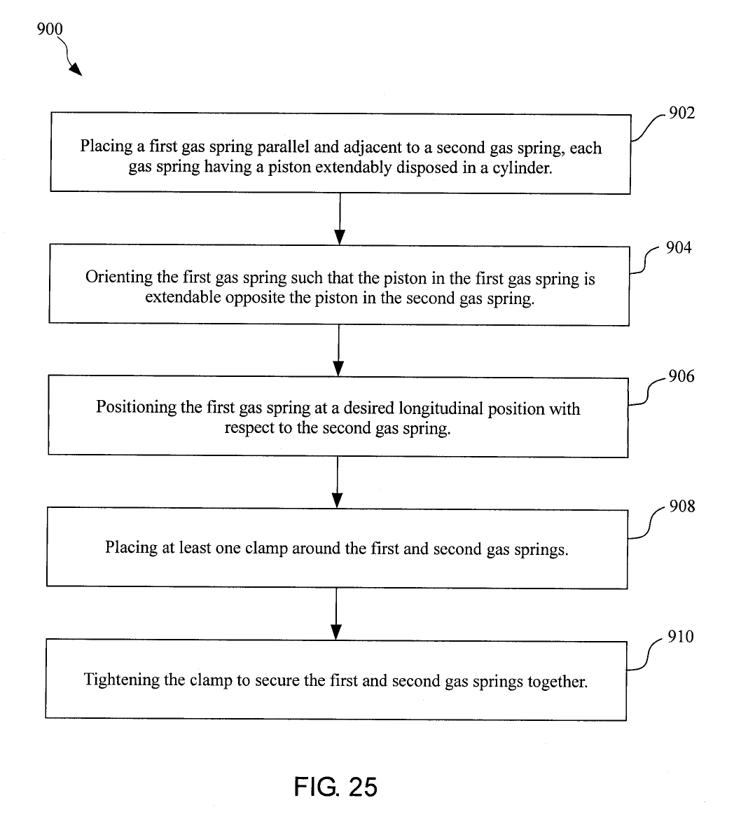

FIG. 25 provides a flowchart depicting a method 900 for making a parallel gas spring, which method includes placing 902 a first gas spring parallel and adjacent to a second gas spring. Each gas spring can have a piston extendably disposed in a cylinder. The method also includes orienting 904 the first gas spring such that the piston in the first gas spring is extendable in the opposite direction of the piston in the second gas spring, and positioning 906 the first gas spring at a desired longitudinal position with respect to the second gas spring. The method further includes placing 908 at least one clamp around the first and second gas springs, and tightening 910 the clamp to secure the first and second gas springs together.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as illustrative, rather than restrictive, and any such modifications or changes are intended to fall within the scope of the present invention as described and set forth herein.

More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, any steps recited in any method or process claims, furthermore, may be executed in any order and are not limited to the order presented in the claims. The term “preferably” is also non-exclusive where it is intended to mean “preferably, but not limited to.” Accordingly, the scope of the invention should be determined solely by the appended claims and their legal equivalents, rather than by the descriptions and examples given above.

What is claimed and desired to be secured by Letters Patent is:

1. A parallel locking gas spring device, comprising:
a) a first gas spring having a first piston extendible from an end of a first cylinder;
b) a second gas spring disposed parallel and adjacent to the first gas spring and having a second piston extendible from an end of a second cylinder in an opposite direction from the first piston; and
c) means for adjustably coupling the first cylinder to the second cylinder to selectively position the first cylinder along a longitudinal length of the second cylinder.

2. A device in accordance with claim 1, wherein the means for adjustably coupling includes:
a) a first holed elongated flange extending from the first cylinder;
b) a second holed elongated flange extending from the second cylinder, the holes of the first flange being selectively alignable with the holes in the second flange; and
c) at least one fastener disposable through the aligned holes to couple the first and second flanges together.

3. A device in accordance with claim 1, wherein the means for adjustably coupling includes a pair of clamps sized and shaped to engage and releasably secure the first and second cylinders together.

4. A device in accordance with claim 3, wherein each of the pair of clamps is selectively positionable at a desired longitudinal position on the first and second cylinders.

5. A device in accordance with claim 1, wherein the first and second gas springs are locking gas springs further including:
an actuator coupled to the first gas spring and the second gas spring and operable to unlock the first piston to allow the first piston to move between a compressed position with respect to the first cylinder and an extended position, and to unlock the second piston to allow the second piston to move between a compressed position and an extended position.

6. A device in accordance with claim 5, wherein the actuator further includes:
a) a handle;
b) a pair of cables, each cable extending from the handle to an actuation lever on a different one of the first gas spring and the second gas spring; and
c) the handle being operable to pull the cables which in turn actuate the actuation levers on each of the gas springs to unlock the first and second pistons substantially simultaneously to allow the first and second pistons to move between the compressed and/or extended positions.

7. A device in accordance with claim 5, wherein the actuator further includes:
a) a first handle with a cable coupled to an actuation lever on the first gas cylinder, the handle being operable to pull the cable which in turn actuates the actuation lever on the first gas spring to unlock the first piston to allow the first piston to move between the compressed and/or extended positions; and
b) a second handle with a cable coupled to an actuation lever on the second gas cylinder, the handle being operable to pull the cable which in turn actuates the actuation lever on the second gas spring to unlock the second piston to allow the second piston to move between the compressed and/or extended positions independently of the position or movement of the first piston.

8. A device in accordance with claim 1, wherein the first gas spring has a different spring force than the second gas spring.

9. A device in accordance with claim 1, wherein the first and second gas springs further comprise piston attachment points located at the distal ends of the first and second pistons, each piston attachment point being configurable to rotate an axis of the piston attachment points between perpendicular to and parallel with a plane of the first and second gas springs.

10. A gas spring device, comprising:
a) a pair of gas springs disposed parallel and adjacent one another, each of the gas springs having a piston extendable in an opposite direction from the piston of the other gas spring; and
b) an adjustable coupling joining the pair of gas springs together, the coupling being adjustable to selectively position one of the gas springs along a longitudinal length of the other gas spring in order increase an overall extended piston-to-piston length of the gas spring device.

11. A method for making a parallel gas spring, comprising:
a) placing a first gas spring parallel and adjacent to a second gas spring, each gas spring having a piston extendably disposed in a cylinder;
b) orienting the first gas spring such that the piston in the first gas spring is extendable opposite the piston in the second gas spring;
c) positioning the first gas spring at a desired longitudinal position with respect to the second gas spring;
d) placing at least one clamp around the first and second gas springs; and
e) tightening the clamp to secure the first and second gas springs together.

12. An inclinable chair having an adjustable parallel locking gas spring device, comprising:
a) a base frame configured to rest upon a support surface;
b) a chair frame movably coupled to the base frame and having at least one inclinable portion; and
c) a parallel locking gas spring device operably coupled to the base frame and the chair frame and configured to selectively incline the inclinable portion of the chair frame to a desired angle with respect to the base frame, the parallel locking gas spring device comprising:
i) a first gas spring having a first piston extendible from a piston end of a first cylinder, the first piston having a distal end attachable to the base frame;
ii) a second gas spring disposed parallel and adjacent the first gas spring and having a second piston extendible from a piston end of a second cylinder in an opposite direction from the first piston, the second piston having a distal end attachable to the inclinable portion of the chair frame; and
iii) means for adjustably coupling the first cylinder to the second cylinder to selectively adjust the position of the first cylinder along a longitudinal length of the second cylinder to increase or decrease an incline range of the inclinable portion of the chair.

13. A chair in accordance with claim 12, wherein the inclinable portion is selected from the group consisting of a backrest, a seat, a backrest rigidly attached to a seat, a leg rest, and combinations thereof.

14. A chair in accordance with claim 13, further comprising:
a) a pivot pin extending from a side frame member of the chair frame; and
b) a flange extending from a side frame member of the base frame corresponding in position to the pivot pin, and having a plurality of vertically spaced holes sized and shaped to receive the pivot pin such that the chair frame can pivot with respect to the base frame about the pivot pin.

15. A chair in accordance with claim 14, wherein the pivot pin can be moved vertically to different vertically spaced holes in the flange in order to raise or lower the chair frame with respect to the base frame.

16. A chair in accordance with claim 12, wherein the at least one inclinable portion includes a backrest and seat rigidly coupled together and simultaneously inclinable by the gas spring device.

17. A chair in accordance with claim 12, wherein the parallel locking gas spring device is coupled to a cross member of the chair frame and a rearward cross member of the base frame and an approximate lateral central location of the cross members.

18. A chair in accordance with claim 12, wherein the chair includes wheels coupled to the base and configured to ambulate the chair.

19. A chair in accordance with claim 12, wherein a distal end of the first cylinder is positioned relatively closer to the distal end of the second cylinder to provide a relatively longer piston-to-piston length of the gas spring device.

20. A chair in accordance with claim 12, wherein a proximal end of the first cylinder is positioned relatively closer to the proximal end of the second cylinder to provide a relatively shorter piston-to-piston length of the gas spring device.

21. A chair in accordance with claim 12, wherein the first gas spring has a different spring force than the second gas spring to provide a selectively variable spring force for different sized occupants of the chair.

22. A chair in accordance with claim 12, wherein the first gas spring is a locking gas spring and the second gas spring is a non-locking gas spring such that the first gas spring selectively locks the chair frame into a selectively inclined angle with respect to the base frame and the second gas spring provides a bouncing shock absorber for an occupant of the chair.

23. A chair in accordance with claim 12, wherein the at least one inclinable portion further includes an inclinable backrest, and inclinable seat, and an inclinable leg rest with each inclinable portion having at least one gas spring device to allow selective positioning of the inclinable portions.
